(19) United States
(12) Patent Application Publication
(10) Pub. No.: US 2022/0198950 A1
(43) Pub. Date: Jun. 23, 2022

(54) System for Virtual Learning

(71) Applicant: 7th Tec GmbH, Langenfeld (DE)

(72) Inventor: Alexander Runge, Langenfeld (DE)

(21) Appl. No.: 17/131,817

(22) Filed: Dec. 23, 2020

(51) Int. Cl. G09B 5/14; G06T 19/00; G02B 27/01

(52) U.S. Cl. CPC G09B 5/14; G02B 2027/0178; G02B 27/017; G06T 19/006

(57) ABSTRACT

A virtual learning system based on virtual reality and augmented reality. According to the invention, a control device and a plurality of mobile terminals, VR glasses for the VR application and headsets for audio presentation, are included. The control device transmits a synchronous video signal which is uniform for all VR glasses or a video signal which is different for groups of VR glasses or for individual VR glasses, from a video storage device to the VR glasses. The control device further transmits from audio storage devices and/or receives from a microphone a synchronous audio signal which is uniform for all headsets or an audio signal which is different for groups of headsets or for individual headsets.

### CROSS REFERENCE TO RELATED APPLICATIONS

None.

### BACKGROUND

The invention relates to a virtual learning system based on virtual reality (VR) and augmented reality (AR). VR refers to the representation and simultaneous perception of reality and its physical properties in a real-time computer-generated, interactive virtual environment. AR is the computer-aided augmentation of reality perception. This information can address all human sensory modalities. However, augmented reality is often understood to mean only the visual representation of information, i.e. the addition of computer-generated supplementary information or virtual objects to images or videos by superimposition or overlay. Since it is a mixture of virtual reality and physical reality, the term mixed reality is also used. Any reference to the term VR application herein also comprises the AR application.

One of the most common types of learning is classroom instruction, where students are expected to follow lessons and teachers. The same applies to other formats of teaching and knowledge transfer. Well-known systems already offer learning using computer resources, such as through online lectures, tutorials, and the like. Such online resources are mostly provided via the Internet using pre- recorded lectures, online audios or video tutorials on a platform.

Such systems are known from the prior art. U.S. Pat. No. 6,857,878 B1 discloses an endoscopic learning system with which an organ can be simulated and the handling of an endoscopic instrument can be trained through virtual reality. However, the learning system is not designed for multiple participants.

A simulation system for training doctor-patient communication situations is known from U.S. Pat. No. 8,469,713 B2, where it is also envisaged to use virtual reality to make the simulation more realistic. However, the simulation system is not designed for multiple participants.

EP 3 200 044 A1 describes a computer-implemented system and method for interactive learning based on virtual reality. The method includes simulating an interactive 3D scene in a VR environment and rendering the interactive 3D scene including queries on a VR display platform. Responses to the requests are received in the VR environment. A first cumulative score is calculated based on the participants' response and attributes. Moreover, subsequent interactive 3D scenes are dynamically simulated in the VR environment based on the first cumulative score. An interactive 3D scene is rendered until the overall score is equal to or greater than a threshold score. While the proposed system is designed for multiple participants, it does not describe how they are connected to the system. Also, it is not possible to distinguish between participants individually.

SUMMARY

The invention relates to a virtual learning system (1) based on virtual reality and augmented reality. According to the invention, a control device (2) and a plurality of mobile terminals, VR glasses (4) for the VR application and headsets (6) for audio presentation, are included. The control device (2) transmits a synchronous video signal (14) which is uniform for all VR glasses (4) or a video signal which is different for groups of VR glasses (4) or for individual VR glasses (4), from a video storage device (8) to the VR glasses (4). The control device (2) further transmits from audio storage devices (10) and/or receives from a microphone (12) a synchronous audio signal (16) which is uniform for all headsets (6) or an audio signal which is different for groups of headsets (6) or for individual headsets (6).

### DETAILED DESCRIPTION

Therefore, it is the object of the present invention to provide a virtual learning system based on virtual reality that enables individual learning in a learning group with focus also on individual users.

The object is achieved by a virtual learning system based on virtual reality. According to the invention, a control device and a plurality of mobile terminals, at least VR glasses for the VR application and headsets for audio transmission, are included. The control device transmits a synchronous video signal which is uniform for all VR glasses or different for groups of VR glasses or for individual VR glasses, from a video memory to the VR glasses. It is envisaged that the control device transmits a synchronous video signal which is uniform for all VR glasses or a video signal which is different for groups of VR glasses or for individual VR glasses from a video storage device to the VR glasses. It is further envisaged that the control device transmits from audio storage devices and/or receives from a microphone a synchronous audio signal which is uniform for all headsets or an audio signal which is different for groups of headsets or for individual headsets.

The VR application or video signal in the sense of the invention comprises, for example, photo, video and a 360° player, as well as 2D and 3D models and interaction applications. Interaction applications with simultaneous or individual start of all terminals are also envisaged. The operator, for example the teacher of a school class, which forms a group of users in the sense of the invention, also has the possibility to access the display of individual terminals in order to be able to offer assistance or explanations.

An advantageous design of the system according to the invention further comprises tablet computers as terminals. A tablet computer, also known as a tablet PC or tablet, is a portable, flat computer of particularly lightweight design with a touchscreen but, unlike notebooks, without a foldable mechanical keyboard. A tablet is a special design of a personal computer that belongs to the handheld devices. Due to the light construction and the touch-sensitive screen, tablets are characterized by easy handling. The devices resemble modern smartphones in terms of scope of functions, operation and design and usually use operating systems originally developed for smartphones. An on-screen keyboard is only displayed when required.

The tablet computers are used, among other things, where restrictions apply for users regarding the use of VR glasses. Restrictions include, for example, the risk of epileptic seizures or motion sickness. In such cases, these users can follow the representations on the screen of the tablet computer.

It has proven advantageous if the audio signal is stored in the control device and/or is spoken in as audio commentary by the operator of the control device using a microphone. This also basically eliminates the need for an Internet connection, which would otherwise be used to receive information from the control device. All users, or their terminals, are connected to a local network for this purpose, which connects them to the operator or the control device. It is a self-contained system that provides all the intended functions at least by means of an intranet to which the control device and the terminals are connected. Content is buffered to the terminals via a server integrated into the system, which includes the video and audio storage devices.

Alternatively, however, the solution according to the invention may also function online via an Internet connection. This enables additional functions such as streaming content from third-party sources, such as learning content, podcasts, audio offerings, videos, VR data, or AR data, by third-party providers. Furthermore, it is possible to take the terminals out of the immediate area of the local network of the control device, e.g. for home schooling, as well as for inter-school teaching, where one teacher as operator can teach several spatially separated groups of users, in particular classes. For this purpose, instead of being connected to the local network of the system, the terminals are connected to the Internet via another network at the place of use, e.g. a locally available WLAN network.

The respective applications may also be triggered, i.e. in particular the playback can be started, but also stopped or influenced in some other way, by simply placing an RFID chip on them. For example, the application of a VR presentation of the Anne Frank House may be played fully automatically on all terminals by applying an RFID card having, for example, the size of a credit card, without the presenter having to interact with the interface.

Further benefits are obtained when the headsets record an audio commentary from the user and transmit it to the operator via the local network or the Internet. This enables communication within the system. There is no need to leave the system for queries; instead, the VR glasses and headset remain on the user. An alternative to this is communication between the operator and the user via audio chat.

For assistance and monitoring, at least individual VR glasses or even all VR glasses may trigger streaming of audio and video signals to the server. Thus, assistance may be provided by means of a voice dialog (audio chat). Audio can take place in single channel as well as in multichannel. The control device, also referred to as a server, alternatively acts as a playback recorder to output the stored content. For all or individual systems or terminals, playback can be stopped, started, paused, and the view, especially the format, speed, or simultaneous display of multiple contents, can be controlled.

A virtual room is used for virtual gathering of users and/or operators and the possibility to share the screen (screen sharing), where users and/or operators can see each other on the shared screen of the VR glasses (6). In this case, 2D presentations are provided in particular.

Advantageously, an exam function is provided that allows the operator to test the user's perception and recollection of the offered content as part of an exam. For this purpose, tablet computers are used in a particularly advantageous way, as they have proven to be very suitable for retrieving exam content.

It has also been shown to be advantageous if the control device is connected wirelessly to the terminals, at least the VR glasses and/or the headsets, or also to the tablet computers if desired. This allows the system to be deployed quickly without first having to make a wired connection, and eliminates the risk of accidents caused by cables lying on the floor. In this case, the connection between the control device and the terminals is established via a wireless WLAN network directly or via the Internet.

Advantageously, the system is stored and transported in a base unit designed, for example, as a mobile roller container. According to an advantageous embodiment, the base unit is equipped with drawers for accommodating at least the VR glasses and headsets. If tablet computers are provided, they are also stored in the base unit. It is particularly convenient if the top cover of the base unit can be folded open. A control panel located under the cover and a screen located in the cover are then released.

The system according to the invention is an all-in-one solution in which all the necessary functions are integrated in and executed by the base unit. The power supply is protected by an uninterruptible power supply (UPS) so that, according to the preferred embodiment, one hour of operation without mains connection is possible. Thus, even in the event of a power failure, the lesson does not have to be interrupted immediately.

A router, which establishes, monitors and controls the local network, and the control device, which includes a control server and in particular a media server, are integrated. The system according to the invention further has a charging station for the terminals and a communication interface to individual devices. The LAN interfaces for a local network are easily accessible.

A preferred embodiment of the system according to the invention includes a sufficient number of VR glasses and multiple headsets for a group of users, e.g. an entire school class. The mobile terminals, the headsets and the VR glasses as well as supplementary tablet systems, in particular tablet computers, are controlled in a hybrid manner or in groups or individually. By specifically selecting users according to their needs and restrictions, no target group is excluded, such as users with epilepsy or motion sickness risk.

The system according to the invention provides a mobile unit, a VR equipment for a group of users, e.g. a whole school class. Generally, no connection to the Internet is required for this. Customized instruction is possible for individual users, because the headsets can be provided with content and addressed via audio commentary individually, universally or in groups. The system works wirelessly and is uncomplicated to set up. For example, VR or AR content is streamed synchronously to all terminals. Communication between the operator and the users, but also between the users themselves, can take place via audio chat, normal chat or via a text overlay in the VR glasses, and alternatively by means of a virtual avatar, i.e. a virtual person which simulates or replaces the operator. Intuitive operation by a teacher or tutor as operator is possible, VR experience or affinity for technology is not required. The software and hardware can be customized for different areas of application or operator or user groups.

The present invention provides a key to digitized education. It is of high added value to experience historical events, destroyed and distant places as well as scientific processes intensively at the push of a button and from a learning space such as a classroom. The mobile, intuitive virtual learning system based on virtual reality according to the present invention complements and digitizes conventional school lessons, making them interactive and inclusive, thus enabling the participation of users with different levels of prior education, and demonstrably raising the level of education. Virtual interactive learning offers countless educational applications that span all subject areas of the core curricula and can be accessed flexibly. It enables students to travel through time and around the world, takes away the high degree of abstraction of scientific processes or mathematical formulas and visualizes them in a way that can be understood by all users. Thus, the system according to the invention is to be understood as a core component of the digitization of education and not only offers added value for teaching, but also prepares users, especially students, for the challenges of a digitized future and thus makes them co-creators.

In addition, the system according to the invention is used in virtual coaching or seminars, in further education and training. In the business sector, the application in virtual showrooms, the use for acquisition and maintenance for companies can also be considered.

Other advantages include

⋅augmenting teaching with VR and AR (for example, science and humanities subjects, languages, arts, and history and sports),

⋅improving inclusion: teaching using VR allows for individualized instruction that takes into account subjective strengths and weaknesses and health limitations,

⋅teaching curriculum-compliant contents in a playful way, thus increasing creativity, learning success and social competence,

⋅contents can always be kept up to date,

⋅benefiting from an ever-growing portfolio of educational contents (in-house productions, third-party contents from a customer, existing contents from government and private institutions, etc.),

⋅holistic didactic concept (developed with educators),

⋅from the perspective of the users (e.g. students): simple operation, possible autonomous use in coordination with the teacher, increase of the individual learning curve.

Further advantages are obtained if the technical function of the system according to the invention is supplemented by:

⋅the provision of supporting materials for course preparation, application support, and follow-up works,

⋅the visualization and dubbing of static content for interactive knowledge transfer,

⋅learning software for knowledge testing after application of the system according to the invention in class (tests and class tests possible).

### BRIEF DESCRIPTION OF THE DRAWINGS

The invention is explained in more detail below by way of a description of exemplary embodiments and their illustration in the corresponding drawings. In the drawings:

FIG. 1: is a schematic view of an embodiment of a virtual reality-based virtual learning system according to the invention; and

FIG. 2: is a schematic perspective view of an embodiment of a roller container for a virtual reality-based virtual learning system according to the invention.

### DETAILED DESCRIPTION OF THE PREFERRED EMBODIMENTS

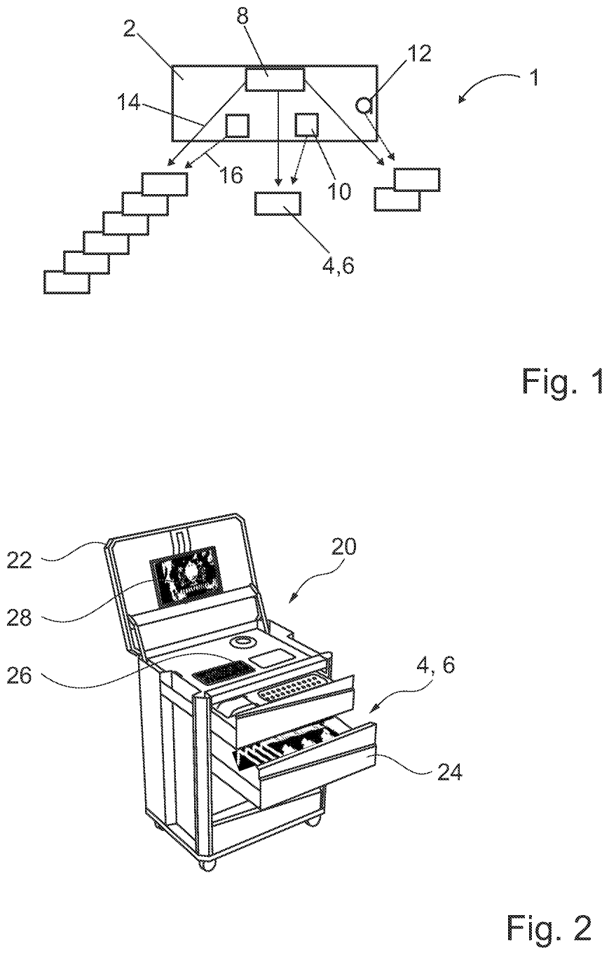

FIG. 1 shows a schematic view of an embodiment of a virtual reality-based virtual learning system 1 according to the invention. A control device 2 comprises a video storage device 8 that stores videos and interaction applications, 3D models, 2D screen sharing for playback on VR glasses 4. Further, audio storage devices 10 in which audio signals are stored for playback on the headsets 6 are part of the control device 2.

The video signal 14 is transmitted uniformly to all VR glasses 4, or to individual selected VR glasses 4, or to a selected group of VR glasses 4 in a controlled manner. In addition, different audio signals 16 are provided which are transmitted from audio storage device 10 to either all or an entire group of headsets 6, or to a single headset. In addition to the audio storage devices 10, a microphone 12 is also connected to the control device 2, which can be used to directly record sound and transmit it as an audio signal 16 to one or more headsets 6, in particular that of the operator. This allows the operator of the control device 2 to send instructions and information directly to, or communicate with, one or more users of the headsets 6.

FIG. 2 shows a schematic perspective view of an embodiment of a roller container 20 for a virtual reality-based virtual learning system according to the invention. Drawers 24 accommodate the headsets 6, VR glasses 4, and other accessories.

In the upper area of the roller container 20, devices for operation are arranged, in particular a control panel 26 including, among other things, a keyboard. The control panel 26 becomes accessible when a cover 22 is opened. A screen 28 is also provided in the cover 22 for displaying instructions or confirming operator inputs, for example.

LIST OF REFERENCE NUMERALS

1 system

2 control device

4 VR glasses, terminal

6 headset, terminal

8 video storage device

10 audio storage device

12 microphone

14 video signal

16 audio signal

20 roller container, base unit

22 cover

24 drawer

26 control panel

28 screen

1. A virtual learning system (1) based on virtual reality and augmented reality, characterized in that a control device (2) and a plurality of mobile terminals, at least VR glasses (4) for the VR application and headsets (6) for the audio presentation, are comprised, wherein the control device (2) transmits a synchronous video signal (14) which is uniform for all VR glasses (4) or a video signal which is different for groups of VR glasses (4) or for individual VR glasses (4) from a video storage device (8) to the VR glasses (4), and wherein the control device (2) further transmits a synchronous audio signal (16) which is uniform for all headsets (6) or an audio signal which is different for groups of headsets (6) or for individual headsets (6) from audio storage devices (10) and/or receives it from a microphone (12).

2. The system according to claim 1, wherein tablet computers are further comprised as terminals.

3. The system according to claim 1, wherein the terminals are connected to a local area network so that a self-contained system is formed which provides all intended functions at least by means of an intranet to which the control device (2) and the terminals (4, 6) are connected, and wherein the contents are buffered to the terminals (4, 6) via a server integrated in the control device (2), said server comprising the video storage device (8) and the audio storage device (10).

4. The system according to claim 1, wherein the terminals (4, 6) are connected to the Internet for online operation, so that additional functions are enabled in online operation.

5. The system according to claim 4, wherein streaming contents from third-party sources, taking the terminals (4, 6) for home schooling, and inter-school teaching in which one operator can teach multiple groups of users are provided as the additional functions.

6. The system according to claim 1, wherein the audio signal (16) is stored in the control device (2) and/or is spoken in as audio commentary for the users of the VR glasses (4) and headsets (6) by the operator of the control device (2) by means of a microphone (12).

7. The system according to claim 6, wherein the headsets (6) record an audio commentary from the user and transmit it to the operator via the local network or the Internet.

8. The system according to claim 6, wherein communication between the operator and the user is performed via audio chat, chat, or text overlay, or alternatively communication with the user is performed via a virtual avatar.

9. The system according to claim 1, wherein the control device (2) acts as a playback recorder and, for all terminals (4, 6) together or for individual terminals (4, 6), playback can be stopped, started, paused, and view controlled.

10. The system according to claim 1, wherein the control device (2) comprises an RFID reader such that the VR application and/or the audio transmission are triggered by means of an RFID card for control on all systems in operation in a fully automated manner by applying the RFID card.

11. The system according to claim 1, wherein the system (1) creates a virtual space dedicated to virtual gathering and the possibility of screen sharing, where users and/or operators can see each other on the shared screen of the VR glasses (6).

12. The system according to claim 1, wherein an exam function is provided that allows the operator to test the users' content perception.

13. The system according to claim 1, wherein the control device (2) is wirelessly connected at least to the VR glasses (4) and/or the headsets (6).

14. The system according to claim 1, wherein the power supply is protected by an uninterruptible power supply (UPS) so that one hour of operation without mains connection is possible.

15. The system according to claim 1, wherein the system (1) is installed, stored and transported in a base unit (20).

16. The system according to claim 15, wherein the base unit (20) is configured as a roller container with drawers (24) for accommodating at least the VR glasses (4) and the headsets (6).

17. The system according to claim 15, wherein the top cover (22) of the base unit (20) can be folded open, exposing a control panel (26) disposed below the cover (22) and a screen (28) disposed within the cover (22).
